(19) United States
(12) Patent Application Publication
(10) Pub. No.: US 2009/0325580 A1
(43) Pub. Date: Dec. 31, 2009

(54) Method and Arrangement in a Telecommunication System

(76) Inventors: Muhammad Ali Kazmi, Bromma (SE); Andras Racz, Budapest (HU); Karl Olof Joakim Bergström, Stockholm (SE); Janne Peisa, Espoo (FI)

Correspondence Address: COATS & BENNETT, PLLC, 1400 Crescent Green, Suite 300, Cary, NC, 27518, US

(21) Appl. No.: 12/443,709

(22) PCT Filed: Oct. 11, 2007
(86) PCT No.: PCT/EP07/08850

§ 371 Date: Jun. 11, 2009

(30) Foreign Application Priority Data
Oct. 12, 2006 (SE) 0602152-1

(51) Int. Cl. H04W 36/00

(52) U.S. Cl. 455/436

(57) ABSTRACT

A method is described of assigning to a user equipment one or more idle gap patterns in uplink and/or downlink communications between the user equipment and a radio base station, to allow the user equipment to perform downlink measurements on neighbour cells during the idle gaps. The method comprises defining a pre-assigned idle gap pattern; and modifying the pre-assigned idle gap pattern on the basis of one or more short commands sent between the user equipment and the radio base station.

The present invention relates to methods and arrangements in a telecommunication system, in particular to a method and arrangement for a semi-dynamic configuration of idle gaps in an Evolved UTRAN.

### BACKGROUND

The E-UTRAN is supposed to support UE mobility within different E-UTRA frequency layers and also the mobility between E-UTRAN and legacy technologies such as UTRAN and GERAN (see, e.g., 3GPP TR25.913, “Requirements for Evolved UTRA (E-UTRA) and Evolved UTRAN (E-UTRAN)”). In order to realize such a mobility scenario the UE should be able to do downlink measurements on other frequencies or on other access technologies without significant performance degradation.

Regarding the handover classification in E-UTRAN, different types of handovers that shall be supported by E-UTRA are depicted in FIG. 1. This classification is useful in understanding which type of handover measurements needs to be carried out during the idle gaps. Intra-LTE handovers are performed within serving or non-serving E-UTRA frequency layers. On the other hand inter-handover refers to inter-RAT handover, which corresponds to handover to UTRA or GERAN systems. The minimum UE bandwidth is 10 MHz whereas the network can deploy up to 20 MHz. Assuming that a 10 MHz UE shall be placed either on the left or right portion of the bandwidth (see, e.g., 3GPP TR25.813, “Evolved Universal Terrestrial Radio Access (E-UTRA) and Evolved Universal Terrestrial Radio Access Network (E-UTRAN); Radio interface protocol aspects”). Thus intra frequency handovers within E-UTRA can further be classified into two categories, as shown on the extreme left of FIG. 1.

Regarding measurement principles in E-UTRAN: In order for the network to perform the above indicated handovers (FIG. 1) the UE shall report different types of measurements including intra-LTE handover as well as inter-RAT related handovers. Intra-LTE measurements shall be done on downlink reference symbols or any other suitable measurable signals. UTRA measurements and GERAN measurements (e.g. carrier RSSI) are already specified in the document 3GPP TS25.215. FIG. 2 illustrates non-gap assisted and gap assisted measurement principles that can be used in E-UTRAN.

Regarding examples of idle gap patterns: In order to perform gap assisted measurements the network needs to configure the gaps as described here. One possible idle gap pattern and the associated parameters is shown in FIG. 3. During the idle gap the UE shall perform downlink measurements. This means that the network scheduler shall not send any data to the UE. On the other hand, between the successive gaps the UE may expect to be scheduled. The parameters associated with the gap patterns are to be signalled to the UE (i.e. pre-configured). The typical gap length can vary between 2 ms and 10 ms. The gap pattern can be configured for a limited duration but also for an infinite amount of time.

Regarding measurement methods for different handover types: It is likely that an E-UTRA UE will only be able to perform non-gap assisted measurement within its serving frequency layer within the reception bandwidth. For all other handover scenarios (intra-frequency HO outside UE reception bandwidth, IF, IRAT etc) the UE will require idle gaps (method B in FIG. 2) on the neighbour cells of the corresponding access technologies to perform measurements. Hence, gap assisted measurements will be key role in UE mobility scenarios in E-UTRAN. The measurement interval (FIG. 4) for each type of measurement can range between 1 second and several seconds. The measurement interval depends upon several factors including the gap pattern, the number of neighbour cells to measure on, the types of measurements to be done simultaneously etc.

### SUMMARY

It has been observed in existing solutions based on a periodic idle gap pattern as described above, that HARQ initial transmission and retransmissions can be delayed. Furthermore, synchronous retransmissions in the uplink can collide with the idle gap periods. As the scheduler is unable to schedule during every gap, an increased resource wastage is possible.

On the other hand, in a method applying full dynamic gaps, each gap for measurement is created by negotiation between the UE and the network. If a downlink measurement on a serving E-UTRA frequency (e.g. CQI estimation etc.) is below a certain level the UE requests the network to schedule a gap. If deemed necessary the network schedules one or more gaps to the UE. Consequently, the UE performs measurements during the assigned gaps. This scheme works in a closed loop fashion but has the drawbacks that it does not address the HARQ interaction with the idle gaps and gaps can only be scheduled in the case that downlink quality deteriorates leaving less options at the network.

In the solution according to the present invention, a method is provided of assigning to a user equipment one or more idle gap patterns in uplink and/or downlink communications between the user equipment and a radio base station, to allow the user equipment to perform downlink measurements on neighbour cells during the idle gaps. The method comprises defining a pre-assigned idle gap pattern; and modifying the pre-assigned idle gap pattern on the basis of one or more short commands sent between the user equipment and the radio base station. The network may dynamically send a command to the UE indicating which specific gap pattern is to be used at a given time. Alternatively, the UE may send a command to the network as to which specific idle gap pattern is to be used. Optionally, the command can also indicate whether the UE shall use a particular gap for downlink measurement or not.

Downlink measurements (CQI etc) are reported to the network quite frequently. Hence, within the scope of the present invention it is possible for the network to take into account the downlink quality measurements before assigning the gaps. Hence this invention implicitly incorporates features of the fully dynamic/closed loop scheme. The semi-dynamic approach according to the present invention leads to more flexibility at the scheduler and also allows the transmission of any outstanding transmissions without unnecessary delay caused by idle gaps.

### BRIEF DESCRIPTION OF THE DRAWINGS

FIG. 1 illustrates handover scenarios supported by E-UTRA.

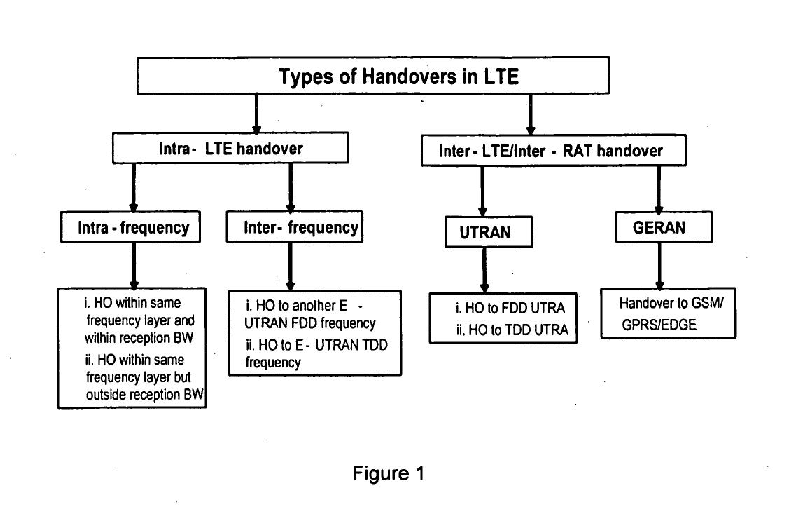

FIG. 2 illustrates methods for facilitating different types of handover measurements.

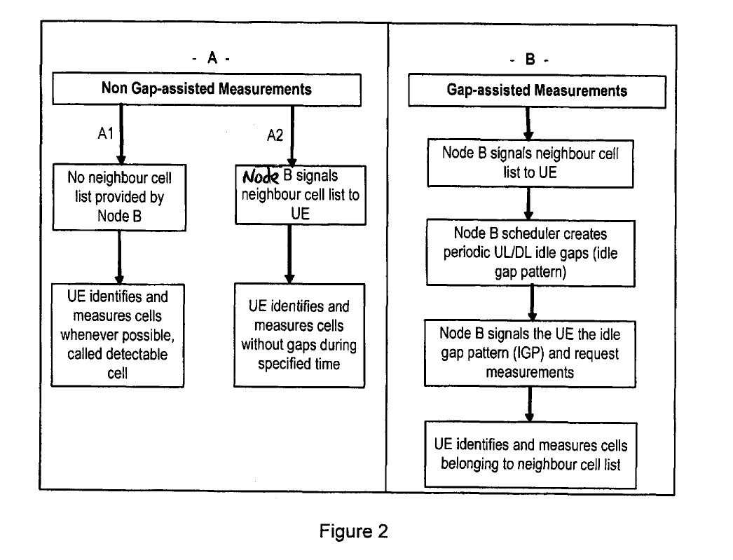

FIG. 3 illustrates the parameters related to an idle gap pattern.

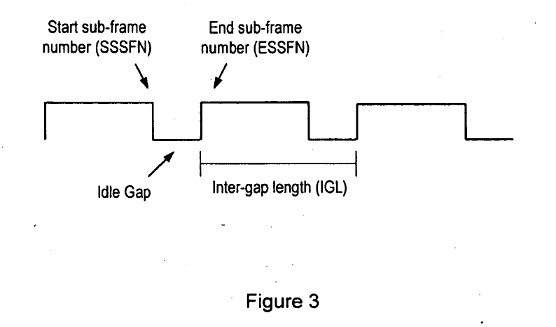

FIG. 4 illustrates a pattern for combined measurements.

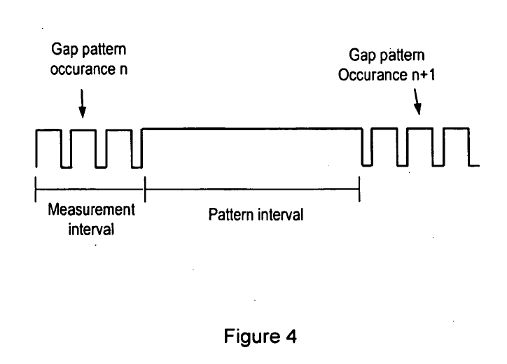

FIG. 5 illustrates part of a wireless telecommunications system according to the present invention.

FIGS. 6a-6c illustrate methods according to the present invention.

### DETAILED DESCRIPTION

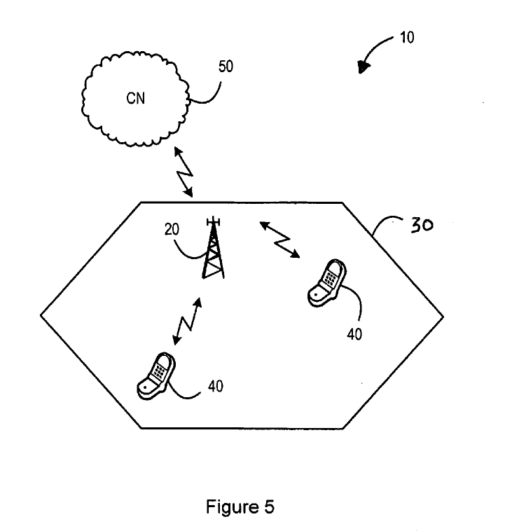

FIG. 5 illustrates part of a wireless telecommunications network 10 according to the present invention.

The telecommunications network 10 comprises at least one radio base station 20 (alternatively called a network node, node B, or any other name familiar to those skilled in the art). The transmission area 30 of the radio base station 20 is shown as a hexagon surrounding the base station; this transmission area 30 is commonly referred to as a cell. Only one base station and its associated cell are shown for convenience; it will be appreciated that the network 10 will typically comprise many such base stations and cells. Cellular phones 40 (also referred to as user equipments) within the cell 30 receive transmissions from the base station 20 on one or more carriers, and send their own transmissions back to the base station 20. A core network (CN) 50, in communication with the base station 20, controls overall operation of the network 10.

Those skilled in the art will appreciate that many elements of the network 10 have been omitted for clarity. The operation of the base station 20 and the user equipments 40 is described in further detail below.

In a static idle gap pattern assignment the gap pattern is assigned to the UE at the start of each measurement and remains unchanged throughout the measurement. During the course of the measurement such a gap pattern is periodic. On the other hand in a semi-dynamic approach as in this invention, the gap pattern or a set of patterns is initially assigned to the UE but during the course of the measurement the gaps can be altered by sending (possibly short) commands. These commands can be sent in the L1/2 control channel, as MAC Control PDUs or as RRC messages. Various embodiments of the present invention in which the gaps can be dynamically modified are discussed in the following sections.

The short commands may be sent from either the network (i.e. a radio base station), or from the UE itself.

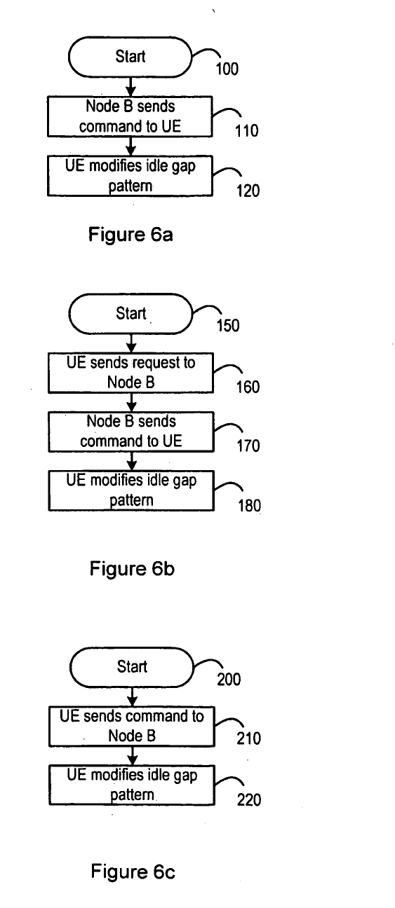

FIG. 6a illustrates one method according to the present invention. The method starts at step 100. According to this method, the network decides that an idle gap pattern needs to be modified. Thus, the network sends one or more short commands to the UE (step 110) to instruct it to modify the idle gap pattern in a particular manner as will be detailed below. In step 120, the idle gap pattern is modified and the method ends.

FIG. 6b illustrates another method according to the invention, in which the UE may have some control over the modification of the idle gap pattern. The method starts at step 150. According to this method, the UE may send a request to the network at step 160 for idle gap pattern modification. Upon receipt of the request, the network may send one or more short commands to the UE at step 170 instructing modification of the idle gap pattern in a particular manner. In step 180, the idle gap pattern is modified and the method ends.

FIG. 6c illustrates a further alternative method according to the present invention. The method starts at step 200. At step 210, the UE sends a short command to the network, informing it that it will be modifying its idle gap pattern. This allows the network to avoid sending transmissions to the UE in an idle gap. In step 220, the UE modifies the idle gap pattern, and the method ends.

Possible modifications to the idle gap patterns are detailed below.

A first embodiment relates to gap omitting: In this method the network configures one periodic gap pattern via RRC (table 1). In addition the UE or the network sends one bit on L1/L2 control indicating whether to skip the next gap(s) or not. This decision could be based on outstanding transmissions, the amount of data in the buffer, radio conditions etc. In the same way the UE could send similar command on L1/L2 control channel, requesting the network to skip the next gap.

TABLE 1
Omit gap (signalling example)

| L1/L2 control | Interpretation |
|---|---|
| 0 | Omit next gap (no DL) |
| 1 | Use next gap (for DL) |

A second embodiment relates to dynamically selecting pre-configured patterns: According to this embodiment the network pre-configures N possible, or potential, periodic gap patterns via RRC (table 2). Each gap can have a different gap length and/or inter-gap length. One of these patterns can also be regarded as the default pattern (e.g. the first pattern). If necessary, the UE or network can request or decide to use another pattern, which belongs to the set of pre-configured patterns. This could be realized by sending M bits (N≦2^{M}) on L1/L2 control channel indicating the pattern to be selected out of N pre-configured ones. One of these pre-configured patterns can also be without gaps. By requesting this pattern the can be omitted in case of outstanding transmissions.

TABLE 2
Dynamically select pattern # (signalling example)

| L1/L2 control | Interpretation |
|---|---|
| 0 | Select pattern #1 |
| 1 | Select pattern #2 |
| . | . |
| . | . |
| . | . |
| N | Select pattern #N |

A third embodiment relates to the network pre-configuring a periodic gap pattern with N possible gap lengths via RRC (table 3). The UE uses the configured gap pattern for the measurements as usual. One of the gap lengths can be a default value. However, if necessary the gap length can be dynamically modified. This can be achieved by the UE or the network by sending M bits (N≦2^{M}) on the L1/L2 control channel indicating the actual gap length to be selected out of N pre-configured ones. In this way gap length is dynamically modified. One pre-configured gap length can be selected as 0, i.e. a gap can be omitted in case of outstanding transmissions.

Another possibility is to pre-configure a gap pattern with N possible inter-gap lengths rather than the gap lengths. In the same way as described above the UE or network can dynamically modify the inter-gap length.

TABLE 3
Dynamically gap length # (signalling example)

| L1/L2 control | Interpretation |
|---|---|
| 0 | Gap length #1 |
| 1 | Gap length #2 |
| . | . |
| . | . |
| . | . |
| N | Gap length #N |

A fourth embodiment relates to a suspended resource assignment. Here, the network also pre-configures one periodic gap pattern via RRC (table 4). The network can send 1 bit of information to the UE to indicate whether the UE shall consider the gap pattern to be on or off. When the gap pattern is off the UE may be scheduled (‘active assignment’) during the gap pattern and may not use the gap pattern to make measurements. When the gap pattern is on the UE will not be scheduled (‘suspended assignment’) and may do measurements during the gap pattern. This command (1 bit) could be sent using the same control channel and message format that is used to signal the downlink resource assignments. Alternatively, the information bits carried in the “suspended” resource assignment could designate a certain idle gap length or pattern from those previously pre-configured via RRC. Indicating idle gaps using this mechanism is beneficial not only for supporting measurements but also for supporting DRX/DTX in the UE.

TABLE 4
Suspended resource assignment (signalling example)

| L1/L2 control | Interpretation |
|---|---|
| 0 | Gap ON |
| 1 | Gap OFF |

Another embodiment relates to a gap start indication whereby only the gap length is pre-configured via RRC. This means the UE uses the same gap length throughout. However, the instant at which the UE will use this gap may be indicated using a few bits in L1/L2 control channel (e.g. resource assignment, scheduling grant). Such information can indicate the sub-frame number at which the UE can start the gap.

According to yet another embodiment no gap pattern is pre-configured. Instead both the start and end of gaps are indicated using L1/L2 control channel. Two variants can be foreseen: In a first variant one additional bit is used to indicate whether this is the start of the gap or the end of the gap. After the start and the end have been indicated the UE will perform a gap corresponding to the time in between the start and the end indications. The second variant is that the L1/L2 control channel includes the information of the gap length, i.e. the gap is started at reception of the information that indicates the length of the pattern.

The following describes one example of a possible implementation regarding neighbour cell measurements within the serving frequency layer:

In a system with frequency reuse=1, mobility within the same frequency layer (i.e. between cells with the same carrier frequency) is predominant. Good neighbour cell measurements are needed for cells that have the same carrier frequency as the serving cell in order to ensure good mobility support and easy network deployment. Searches for neighbour cells with the same carrier frequency as the serving cell, and measurements of the relevant quantities for identified cells are needed. To avoid UE activity outside the DRX/DTX cycle, the reporting criteria for neighbour cell measurements should match the used DRX/DTX cycle. The UE may be able to identify and measure the E-UTRA intra frequency neighbour cells inside the UE reception bandwidth, without any UL/DL idle gaps. The UE may identify and measure cells belonging to the neighbour cell lists provided by the network as well as detectable cells, which are not included in the neighbour cell list. The UE may be able to identify and measure the E-UTRA intra frequency neighbour cells outside the UE reception bandwidth during UL/DL idle gaps created by the network. The UE may identify and measure cells only belonging to the neighbour cell lists provided by the network.

For neighbour cell measurements of other frequency layers: Regarding mobility between different frequency layers (i.e. between cells with a different carrier frequency), the UE may need to perform neighbour cell measurements during DL/UL idle periods that are provided by DRX/DTX or packet scheduling (i.e. gap assisted measurements). The UE may identify and measure only cells belonging to the neighbour cell lists provided by the network.

Regarding inter-RAT handovers from E-UTRAN: Measurements to be performed by a UE for inter-RAT mobility can be controlled by E-UTRAN, using broadcast or dedicated control. In RRC_CONNECTED state, a UE may follow the measurement parameters specified by RRC or MAC commands (FFS) directed from the E-UTRAN (e.g. as in UTRAN MEASUREMENT_CONTROL). The UE performs inter-RAT neighbour cell measurements during DL/UL idle periods that are provided by the network through suitable DRX/DTX period or packet scheduling if necessary. The UE may identify and measure only GERAN and UTRAN cells belonging to the neighbour cell lists provided by the network.

1-28. (canceled)

29. A method of assigning to a user equipment one or more idle gap patterns in uplink and/or downlink communications between the user equipment and a radio base station, to allow the user equipment to perform downlink measurements on neighbor cells during the idle gaps, the method comprising:
defining a pre-assigned idle gap pattern; and
modifying the pre-assigned idle gap pattern based on one or more short commands sent between the user equipment and the radio base station.

30. The method of claim 29 wherein the radio base station sends said one or more short commands to the user equipment.

31. The method of claim 30 further comprising the user equipment sending a request to modify the pre-assigned idle gap pattern to the radio base station prior to the radio base station sending said one or more short commands to the user equipment.

32. The method of claim 29 wherein the user equipment sends said one or more short commands to the radio base station.

33. The method of claim 29 wherein modifying the pre-assigned idle gap pattern comprises the user equipment ceasing the downlink measurement in a next gap in the pre-assigned idle gap pattern.

34. The method of claim 29 wherein modifying the pre-assigned idle gap pattern comprises the user equipment selecting an idle gap pattern from one of a plurality of pre-configured idle gap patterns.

35. The method of claim 29 wherein modifying the pre-assigned idle gap pattern comprises the user equipment increasing or decreasing at least one of a duration of a gap and a duration between successive gaps of the pre-assigned idle gap pattern.

36. The method of claim 29 further comprising the radio base station sending a command to the user equipment indicating whether the user equipment shall be scheduled or shall not be scheduled for data transmission.

37. The method of claim 36 further comprising suspending the pre-assigned idle gap pattern if the user equipment is scheduled for data transmission, and re-activating the pre-assigned idle gap pattern for downlink measurements if the user equipment is not scheduled for data transmission.

38. The method of claim 29 further comprising the radio base station sending a command to the user equipment indicating an instance in time when a gap associated with the pre-assigned gap pattern shall start.

39. The method of claim 38 further comprising the radio base station sending a command to the user equipment indicating a length of the gap.

40. The method of claim 29 further comprising at least one of the user equipment and the radio base station sending each short command via a user equipment specific physical layer control channel.

41. The method of claim 29 further comprising at least one of the user equipment and the radio base station sending each short command via a medium access control layer in one of a medium access control layer header and a medium access control layer protocol data unit.

42. The method of claim 29 wherein the neighbor cells belong to serving carrier frequencies of an Evolved Universal Terrestrial Radio Access Network (E-UTRAN) system.

43. The method of claim 29 wherein the neighbor cells belong to non-serving carrier frequencies of an Evolved Universal Terrestrial Radio Access Network (E-UTRAN) system.

44. The method of claim 29 wherein the neighbor cells belong to carrier frequencies of a Universal Terrestrial Radio Access Network (UTRAN) system.

45. The method of claim 29 wherein the neighbor cells belong to carrier frequencies of a Global System for Mobile communications Enhanced Data rates for GSM Evolution Radio Access Network (GERAN) system.

46. The method of claim 29 wherein the neighbor cells belong to non-serving carrier frequencies of an Evolved Universal Terrestrial Radio Access Network (E-UTRAN) system.

47. A user equipment for use in a wireless telecommunications system, said wireless telecommunications system including at least one radio base station, and wherein said user equipment utilizes a pre-configured idle gap pattern for downlink measurements, said user equipment configured to:
modify said pre-configured idle gap pattern based on one or more short commands sent between the user equipment and the radio base station.

48. The user equipment of claim 47 further comprising a transmitter configured to send said one or more short commands to the radio base station.

49. The user equipment of claim 47 further comprising a receiver configured to receive said one or more short commands from the radio base station.

50. The user equipment of claim 47 further comprising a receiver to receive said one or more short commands from the radio base station via a user equipment specific physical layer control channel.

51. The user equipment of claim 47 further comprising a receiver configured to receive said one or more short commands from the radio base station via a medium access control layer in at least one of a medium access control layer header and a medium access control layer protocol data unit.

52. The user equipment of claim 49 further comprising a transmitter configured to send a request to said radio base station requesting modification of the pre-configured idle gap pattern.

53. A radio base station for use in a wireless telecommunications system, said wireless telecommunications system including at least one user equipment that utilizes a pre-configured idle gap pattern for downlink measurements, said radio base station configured to:
modify said pre-configured idle gap pattern based on one or more short commands sent between the user equipment and the radio base station.

54. The radio base station of claim 53 further comprising a receiver configured to receive said one or more short commands from the user equipment.

55. The radio base station of claim 53 further comprising a transmitter configured to send said one or more short commands to the user equipment.

56. The radio base station of claim 55 further comprising a receiver configured to receive a request from said user equipment requesting modification of the pre-configured idle gap pattern.
